(19) United States
(12) Patent Application Publication
(10) Pub. No.: US 2017/0067625 A1
(43) Pub. Date: Mar. 9, 2017

(54) LIGHT ASSEMBLY

(71) Applicant: Gold Crest, LLC, Santa Barbara, CA (US)

(72) Inventors: Roger Edgar, Santa Barbara, CA (US); Leonardus Josephus van Oor, Voorschoten (NL)

(73) Assignee: GOLD CREST LLC, Santa Barbara, CA (US)

(21) Appl. No.: 14/848,078

(22) Filed: Sep. 8, 2015

(51) Int. Cl. F21V 23/06; H01R 25/00; H01R 27/00; H01R 24/62; F21S 6/00; F21V 33/00

(52) U.S. Cl. CPC F21V 23/06; F21S 6/002; F21V 33/0048; H01R 27/00; H01R 24/62; H01R 25/006; F21Y 2115/10

(57) ABSTRACT

A multi-function light assembly is disclosed having a base and providing a plurality of universal sockets. The light assembly further includes a lamppost attached to the base, the lamppost having an upstanding portion, a cantilevered portion, and curved portion therebetween. The base includes a bottom surface formed of a pad of tacky material, e.g., sticky polyurethane pad, that enhances friction contact with the corresponding surface top. The pad provides a strong, non-adhesive bond to a surface to enhance stability. As a result, the base can have a comparatively small footprint and still achieve appropriate stability requirements.

### FIELD OF THE INVENTION

The present invention relates generally to light assemblies and, more particularly, multi-function light assemblies.

### BACKGROUND OF THE INVENTION

In the field of hardware for service provider, such as for hotels, conference centers or cafes, there are many lighting solutions, which are designed to be placed on a desk. Similarly, there are many universal power adapters that serve to allow an international traveler to plug in their foreign device to a native power outlet.

In service providing areas that cater to multiple individuals, such as hotels, cafes, and conference centers, there is a need for more selective lighting than illuminating the entire room. This need is typically met with desktop lighting solutions. Desktop lighting solutions are typically corded, or wired, removing the need to charge or replace batteries. They are designed to be low profile as to fit on a desk or tabletop; the larger the profile the more usable area consumed on the desk. Typically, these designs incorporate an anchoring mechanism such as a clip, weights, or a wide foundation to keep the device steady. Ultimately, however these characteristics limit the type of consumers who are able to use the existing solutions, areas the solutions can be used in, or functions for which they can be used. Stability is sacrificed for mobility or efficient placement, and traditional anchoring hardware is limited by the consumer ability to operate them.

People traveling, or possessing electronic devices from different countries, encounter the issue of incompatible native power outlets. Power adapters address this issue, allowing specific foreign devices to fit into native outlets via the adapter. Universal power adapters allow an international traveler, or someone possessing a foreign electronic device, to utilize one universal power adapter instead of a specific adapter for each different power outlet. However, it still requires a user to bring, or purchase, at least one universal adapter. Another solution is to install universal international wall sockets in areas frequented by international travelers, such as hotels, conference centers, or cafes. This approach is ultimately unsuccessful for two reasons. First, it requires the purchase of new hardware to retrofit existing working standard wall outlets. This creates waste of a potentially perfectly good infrastructure with no promise the upgrade will ever fully be utilized. Second, it requires laborious installation, further raising the cost. As the current solutions stand, either the international traveler or user is burdened with the need to bring a universal power adapter with them, or a location servicing international clientele is burdened with augmenting infrastructure.

With these two issues seen in combination, it must be appreciated that there remains a need for a solution that provides low-profile, mobile, yet stable desktop lighting, while also providing power conversion for foreign electronic devices without a burden to user or service providers.

It should be appreciated that there remains a need for a light assembly that addresses these concerns. The present invention fulfills this need and others

### SUMMARY OF THE INVENTION

Briefly, and in general terms, the invention is embodied in portable multi-function light assembly having a base and providing a plurality of universal sockets. The light assembly further includes a lamppost attached to the base, the lamppost having an upstanding portion, a cantilevered portion, and curved portion therebetween. The base includes a bottom surface formed of a pad of tacky material, e.g., sticky polyurethane pad, that enhances friction contact with the corresponding surface top. The pad provides a strong, non-adhesive bond to a surface to enhance stability. As a result, the base can have a comparatively small footprint and still achieve appropriate stability requirements

More specifically, in an exemplary embodiment, the receptacles of each socket form a T-shape profile for the socket. The sockets are oriented 180 degrees from each other, which facilities easy attachment of multiple plugs. In the exemplary embodiment, the sockets are disposed on the top wall of the base, which further facilitates stability of the light assembly during attachment and removal of plugs.

In a detailed aspect of an exemplary embodiment, a shelf assembly coupled to the base for supporting a mobile device, the shelf assembly provides a recess defined aft of a front wall of the shelf assembly for concealing a charging cable for the mobile device, the shelf assembly is attached to the upstand portion of the lamp post such that the recess is defined between the front wall of the shelf and the upstanding portion and the recess is sized to conceal a terminal plug of a charging cable for a mobile device.

In another detailed aspect of an exemplary embodiment, the base further provides USB power ports on the left and the right sides of the base, which can be used charge mobile devices. A USB charging cable can be connected to one of the USB ports with the opposing end of the cable attached to the mobile device. The recess provides space to allow the cable to be attached to the charging port of the mobile device, while the mobile device conveniently rests on the shelf.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a front perspective view of a multifunction light assembly in accordance with the invention, depicting a mobile device disposed on a shelf

FIG. 2 is a back perspective view of the light assembly of FIG. 1.

FIG. 3 is a top view of the base of the light assembly of FIG. 1.

FIG. 4 is a left side view of the light assembly of FIG. 1.

FIG. 5 is a right side view of the light assembly of FIG. 1.

FIG. 6 is a back view of the light assembly of FIG. 1.

FIG. 7 is a table listing 15 types of electrical outlet plugs and sockets, as designated by US Department of Commerce International Trade Administration (ITA).

### DETAILED DESCRIPTION OF THE PREFERRED EMBODIMENTS

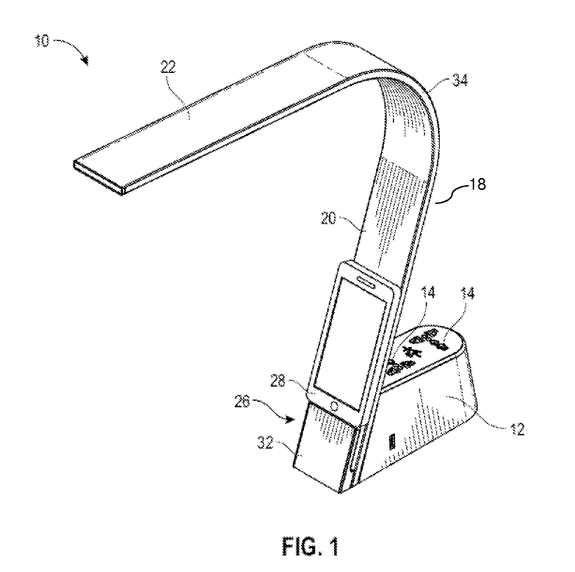

Referring now to the drawings, and particularly FIG. 1, a portable multi-function light assembly 10 having a base 12 and providing a plurality of universal sockets 14 disposed on the top wall 16 thereof. The light assembly includes an elongated planar lamppost 18 having an upwardly projecting portion 20 and a cantilevered portion 22 that comprises a plurality of lights 24. The multifunction light assembly also includes the shelf assembly (holder) 26 for supporting a mobile device 28. The shelf assembly provides a recess 30 defined aft of a front wall 32 of the shelf assembly for concealing the charging cable for the mobile device. The multi-function light assembly provides effective task lighting in the desk environment, while enabling the user to charge a mobile device. The user can further use devices having any type AC plug without need providing an adapter. As such, the multifunction light assembly is particularly useful for international travelers.

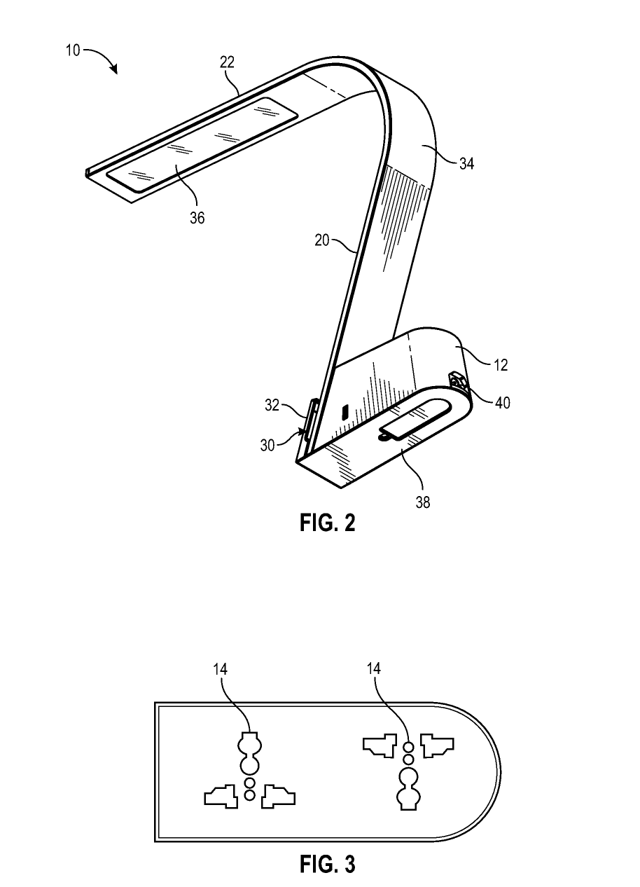

The lamppost 18 includes the upwardly projecting portion 20, the cantilevered portion 22, and a curved portion 34 therebetween. The upwardly projecting portion 20 has a slight reward angle, while providing ample space above the base to access the sockets 14. The curved section is sized to project the cantilevered portion over a workspace on the support surface (e.g., desk) space forward of base. As best seen in FIG. 2, the cantilevered portion 22 provides lighting directed towards the workspace. In the exemplary embodiment, the lighting comprises a plurality of LED lights dispose behind a panel 36.

In the exemplary embodiment, the lamppost 18 has a constant width and thickness along the length thereof. The lamppost 18 is attached to the base 12, in the present embodiment, along a front wall of the base. The shelf 26 is attached to bottom end of the lamppost, thereby defining the recess 30 between the front wall 32 of the shelf and the lamppost 18.

With reference again to FIG. 2, the base 12 includes a bottom surface 38 formed of a pad of tacky material, e.g., sticky polyurethane pad, that enhances friction contact with the corresponding surface top. The pad provides a strong, non-adhesive bond to a surface to enhance stability. As a result, the base can have a comparatively small footprint and still achieve appropriate stability requirements (e.g., as set by UL, LLC (UL®)).

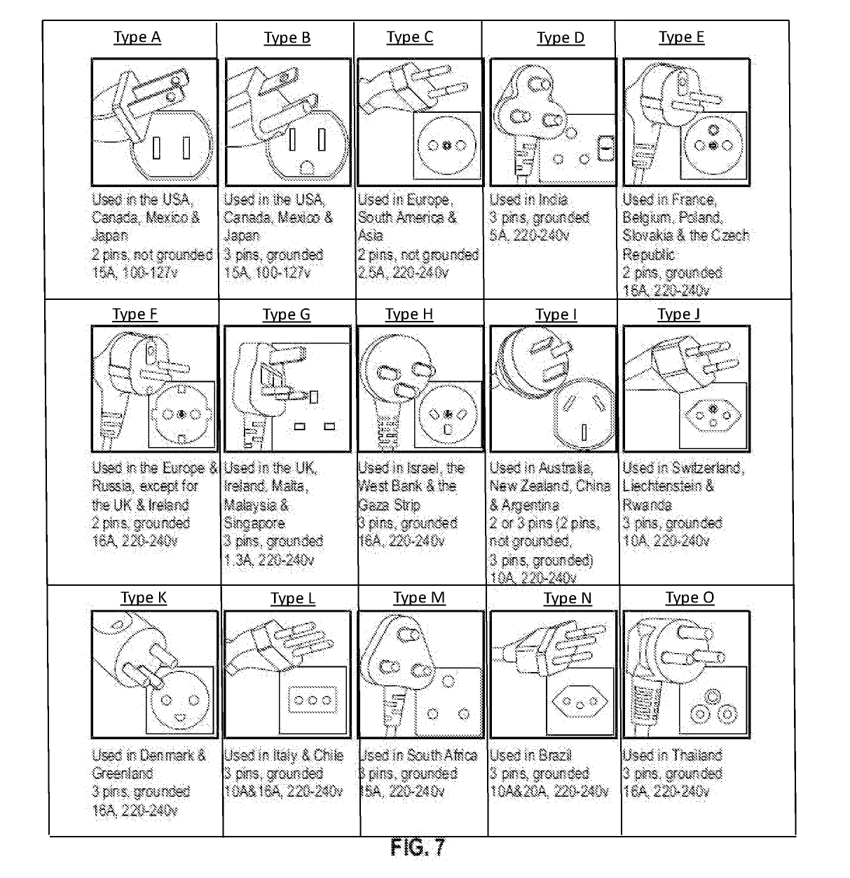

As best seen in FIG. 3, two universal sockets 14 are provided on the top wall of the base 12. Each socket includes a plurality of receptacles configured to receive a variety of electrical outlet plugs. As is known to those of original skill in the art, the U.S. Department of Commerce, International Trade Administration (“ITA”), has identified 15 types of electrical plugs in use worldwide, which are labeled in alphabetical order, types A through O, (, “ITA-type plugs”). The plug and socket types are listed in FIG. 7, for convenient reference. The full specifications and parameters of the plug and sockets, as set forth by the ITA are hereby incorporated by reference for all purposes.

The receptacles of each socket 14 form a T-shape profile for the socket. The sockets 14 are oriented 180 degrees from each other, which facilities easy attachment of multiple plugs in a compact area. In the exemplary embodiment, the sockets 14 are disposed on the top wall of the base, which further facilitates stability of the light assembly during attachment and removal of plugs.

In an exemplary embodiment, the universal sockets 14 are configured to be operable with at least the following types: A, B, C, E, F, and D. In another embodiment, in addition to the preceding, the universal sockets 14 can further be operable with the following types: H, I, J, K, L, and M. In yet another embodiment, in addition to the preceding, the universal sockets 14 are further operable with types N and O.

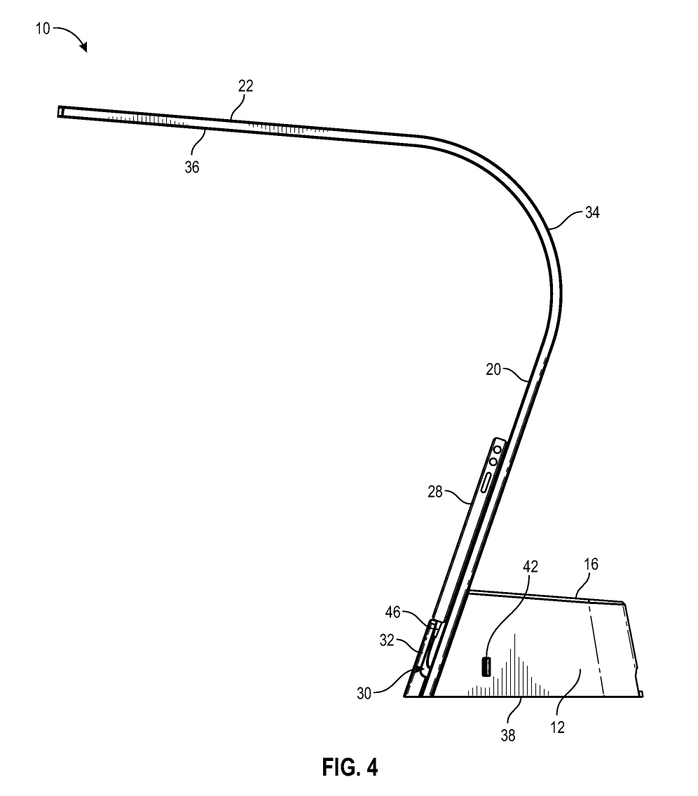

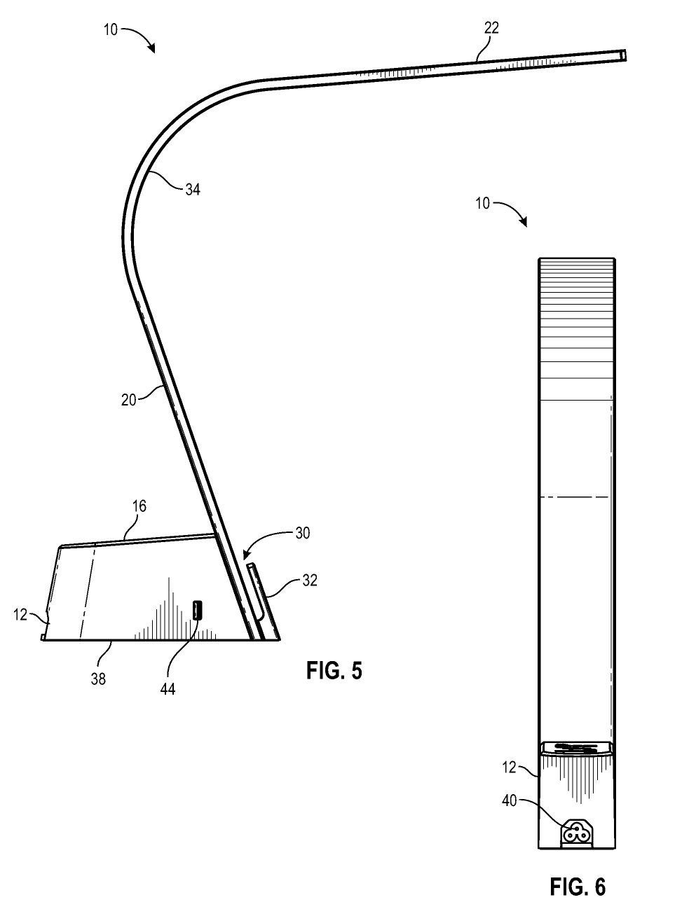

With reference now to FIGS. 4 and 5, the base 12 further provides USB power ports 42, 44 on the left and the right sides of the base 12, which can be used charge mobile devices 28. A USB charging cable 46 can be connected to one of the USB ports 42, 44, with the opposing end of the cable attached to the mobile device. The recess 30 provides space to allow the cable 46 to be attached to the charging port of the mobile device 28, while the mobile device conveniently rests on the shelf 26.

With reference to FIG. 6, the base 12 includes a power socket 40 for attaching a power cord (not shown) to provide power to the assembly 10. The base has thin width that that is substantially equal to the width of the lamppost 18. As discussed above, the bottom 38 of the base pad of tacky material, e.g., sticky polyurethane pad, that enhances friction contact with the corresponding surface top. As a result, the base can have a comparatively small footprint and still achieve appropriate stability requirements.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. A multi-function light assembly, comprising:
a base having a bottom that engages a mounting surface, the base defining a plurality of universal sockets, the bottom having a polyurethane pad that provides that engages the mounting surface, the universal sockets configured to operatively accept at least four types of ITA-type electrical plugs; and
a lamppost attached to the base, the lamppost having an upstanding portion, a cantilevered portion, and curved portion therebetween.

2. The light assembly as defined in claim 1, wherein the lamppost is attached to a front wall of the base.

3. The light assembly as defined in claim 1, wherein the universal sockets are operable with at least the following ITA-type plugs: A, B, C, E, F, and D.

4. The light assembly as defined in claim 1, wherein the lamppost is planar having a constant width.

5. The light assembly as defined in claim 1, wherein the upstanding portion is disposed at a rearward angle and the curved section is sized to project the cantilevered portion over a workspace forward of the base.

6. The light assembly as defined in claim 1, wherein the base further includes a USB power port.

7. The light assembly as defined in claim 1, wherein the plurality of universal sockets each have a T-shape profile and each socket is oriented 180 degree relative to an adjacent socket.

8. A multi-function light assembly, comprising:
a base having a bottom that engages a mounting surface, the base defining a plurality of universal sockets, the bottom having a polyurethane pad that provides that engages the mounting surface, the universal sockets configured to operatively accept at least four types of ITA-type electrical plugs;
a lamppost attached to the base, the lamppost having an upstanding portion, a cantilevered portion, and curved portion therebetween; and
a shelf assembly coupled to the base for supporting a mobile device, the shelf assembly provides a recess defined aft of a front wall of the shelf assembly for concealing a charging cable for the mobile device.

9. The light assembly as defined in claim 8, wherein the base further includes a USB power port.

10. The light assembly as defined in claim 8, wherein the universal sockets are operable with at least the following ITA-type plugs: A, B, C, E, F, and D.

11. The light assembly as defined in claim 8, wherein the plurality of universal sockets each have a T-shape profile and each socket is oriented 180 degree relative to an adjacent socket.

12. The light assembly as defined in claim 8, wherein the shelf assembly is attached to the upstand portion of the lamp post such that the recess is defined between the front wall of the shelf and the upstanding portion and the recess is sized to conceal a terminal plug of a charging cable for a mobile device.

13. A multi-function light assembly, comprising:
a base having a bottom that engages a mounting surface, the base defining a plurality of universal sockets on a top wall thereof, the bottom having a polyurethane pad that provides that engages the mounting surface, the universal sockets configured to operatively accept at least four types of ITA-type electrical plugs, the base further includes a USB power port define along a sidewall thereof;
a lamppost attached to the base, the lamppost having an upstanding portion, a cantilevered portion, and curved portion therebetween, the lamppost is planar having a constant width, the upstanding portion is disposed at a rearward angle and the curved section is sized to project the cantilevered portion over a workspace forward of the base; and
a shelf assembly coupled to the base for supporting a mobile device, the shelf assembly provides a recess defined aft of a front wall of the shelf assembly for concealing a charging cable for the mobile device, the shelf assembly is attached to the upstand portion of the lamp post such that the recess is defined between the front wall of the shelf and the upstanding portion and the recess is sized to conceal a terminal plug of a charging cable for a mobile device.

14. The light assembly as defined in claim 13, wherein the plurality of universal sockets each have a T-shape profile and each socket is oriented 180 degree relative to an adjacent socket.

15. The light assembly as defined in claim 13, wherein the lamppost is attached to a front wall of the base.

16. The light assembly as defined in claim 13, wherein the universal sockets are operable with at least the following ITA-type plugs: A, B, C, E, F, and D.

17. The light assembly as defined in claim 16, wherein the universal sockets are further operable with the following ITA-type plugs: H, I, J, K, L, and M.
